(19) United States
(12) Patent Application Publication
(10) Pub. No.: US 2009/0079406 A1
(43) Pub. Date: Mar. 26, 2009

(54) High-voltage tolerant low-dropout dual-path voltage regulator with optimized regulator resistance and supply rejection

(76) Inventors: Chaodan Deng, Portland, OR (US); Nasser A. Kurd, Portland, OR (US); George Geannopoulos, Portland, OR (US)

Correspondence Address: KED & ASSOCIATES, LLP;INTEL CORPORATION, P.O. BOX 221200, CHANTILLY, VA, 20153-1200, US

(21) Appl. No.: 11/902,922

(22) Filed: Sep. 26, 2007

(51) Int. Cl. G05F 5/08

(52) U.S. Cl. 323/280

(57) ABSTRACT

A voltage regulator includes an amplifier having first and second outputs, a feedback path coupled between a first input and the first output of the amplifier, and a feed-forward path between the second output of the amplifier and a switch coupled to a reference potential. In operation, a first control signal from the second output of the amplifier is generated based on a comparison of a reference signal and a feedback signal into the first input of the amplifier. The first control signal controls the switch to maintain a substantially constant supply voltage. A second control signal is generated along the feedback path to control controls the amount of supply voltage.

### FIELD

The present invention relates in at least some of its embodiments to voltage regulation.

### BACKGROUND

On-die low dropout voltage regulators have been used to provide low-noise power supplies phase-locked loop (PLL) circuits. As shown in FIG. 1, a traditional linear LDO regulator has three main components: a differential (error) amplifier 1, a second amplifier 2, and a power transistor 3. One input of the differential amplifier monitors a percentage of the regulator based on the output of a voltage divider 4. The second input is a bandgap reference voltage, Bgref. In operation, when the output voltage (Vccpll) of the regulator varies relative to the reference voltage, drive to the power transistor changes in order to maintain a constant output voltage.

While LDO regulators have proven useful in many applications, they have performance limitations and problems with reliability, which are especially noticeable when a relative high power supply is used to power the regulator. These effects are particularly severe in PLL applications when, for example, the PLL goes in and out of power saving mode and the regulator output experiences hundreds of millivolts of step-function type changes. Moreover, traditional LDO regulator designs require too many components, which reduce valuable die space and increase circuit complexity.

### BRIEF DESCRIPTION OF THE DRAWINGS

FIG. 1 is a diagram showing one type of low dropout voltage regulator.

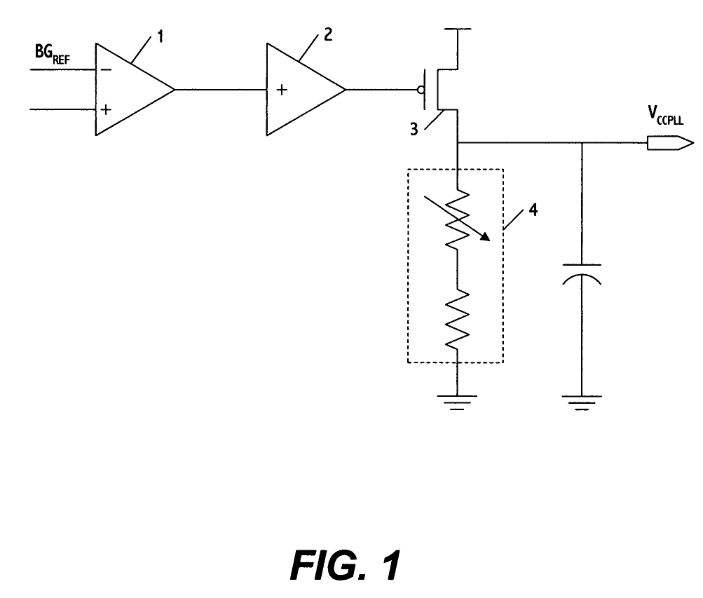

FIG. 2 is a diagram showing another type of low-dropout voltage regulator having dual output paths in accordance with one embodiment of the present invention.

FIG. 3 is a diagram showing a more detailed view of the voltage regulator in FIG. 2.

FIGS. 4a and 4b are graphs showing an example of the performance that may be achieved by the voltage regulator of FIG. 2.

### DETAILED DESCRIPTION

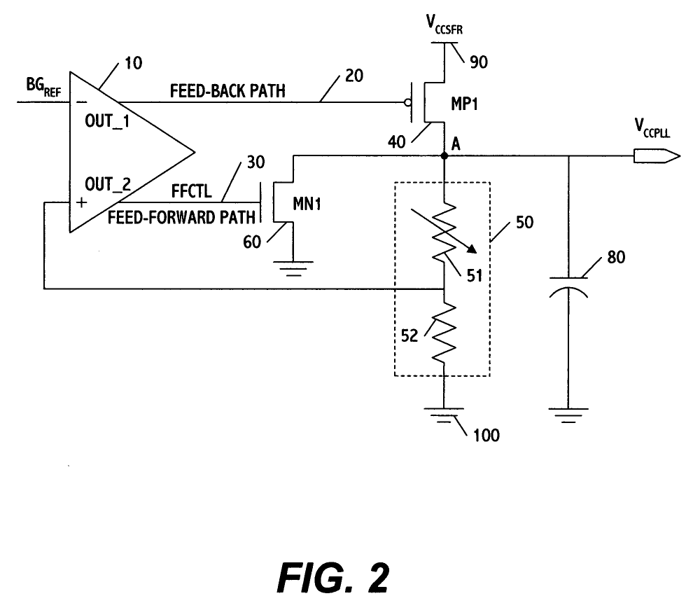

FIG. 2 shows a low-dropout dual-path voltage regulator in accordance with one embodiment of the present invention. This regulator uses only one amplifier 10 with two outputs to perform voltage regulation. The first output forms part of a feedback path 20 and the second output forms part of a feed-forward path 30 for generating a control signal (ffctl) for regulating the supply voltage corresponding to the regulator output.

The feedback path is located between the first output, Out_{—}1, of the amplifier and the non-inverting input of the amplifier, and includes a first control transistor 40 and a voltage divider 50 formed from resistors 51 and 52. The first control transistor 40 (e.g., a voltage adjuster) is coupled between a voltage source 90 (e.g., supply voltage Vccsfr) and an output node A. One of the resistors, e.g., 51, may be a variable resistor. In this case, the ratio of the voltage divider may be set by adjusting resistor 51.

The feed-forward path leads from the second output, Out_{—}2, of the amplifier into the gate of a second control transistor 60. The first and second control transistors 40 and 60 are shown as having opposite conductivities, but in alternative embodiments different transistor types may be used. The feedback path intersects the feed-forward path at output node A, which outputs the regulated supply voltage, Vccpll. According to one application, the regulated supply voltage may be used as the supply voltage for a phase-locked loop, as the suffix “ccpll” indicates. However, in other embodiments, the supply voltage may be input into different circuits, and moreover virtually any type of circuit that requires a regulated voltage or power supply.

In operation, the amplifier serves to maintain a substantially constant supply voltage in spite of process, temperature, or other variations that may otherwise cause this voltage to fluctuate. To maintain a constant supply voltage, the amplifier operates to compare a feedback voltage proportional to supply voltage Vccpll to a reference voltage, which, for example, may be a bandgap reference voltage. Under normal operating conditions, the feedback voltage, generated from Out_{—}1 and input into the non-inverting terminal of amplifier 10, equals the reference voltage and as a result the amplifier outputs a control signal (e.g., an analog voltage) which controls the amount of voltage transferred through the source and drain of transistor 40 from the voltage source 90.

The supply voltage charges capacitor 80, which operates not only to store a voltage proportional to Vccpll but also to prevent rapid fluctuations in the supply voltage especially when the inputs into the amplifier are different. In this latter case, the capacitor may therefore be said to perform a smoothing operation which helps to maintain a constant supply voltage.

The second output, Out_{—}2, is also indicative of the difference in the amplifier inputs. Because the amplifier inputs are the same, another control signal is supplied to the gate of transistor 60 from the second output, Out_{—}2, of the amplifier. This control signal couples output node A to reference potential 100 through transistor 60, and consequently no adjustment is made to the supply voltage, Vccpll. In accordance with at least one embodiment, the control signal from Out_{—}2 may be considered a first control signal and the control signal from Out_{—}1 may be considered a second control signal.

When the feedback voltage into the amplifier does not equal the reference voltage, at least to within some predetermined tolerance, both amplifier outputs may assume a same voltage. That is, the second control signal from Out_{—}1 controls transistor 40 along the feedback path and the first control signal from Out_{—}2 controls transistor 60 along the feed-forward path. When transistor 60 turns on more or less, a signal path to reference potential 100 (e.g., ground) is established which corrects, or helps maintain, the supply voltage at a predetermined constant value.

Thus, for example, when the supply voltage surges, a difference or error signal is supplied to the feed-forward path. This signal controls transistor 60 to reduce the voltage at node A, which reduces the voltage stored in the capacitor. This voltage continues to decline until the supply voltage returns to the predetermined constant value. When this occurs, the feedback voltage into the amplifier will equal the reference voltage, at which time transistor 60 reaches an equilibrium state and the voltage Vccpll from source Vccsfr is changed back to the constant value through transistor 40. Likewise, the feedback path experiences similar actions to keep the voltage Vccpll constant.

Using this one-amplifier design, the voltage regulator demonstrates high supply-voltage tolerance, and also allows for supply rejection optimization while maintaining positive regulator resistance for a given efficiency target. These effects serve to avoid power grid oscillation which translates into improved performance and reliability of the circuit (e.g., PLL) receiving the regulated output. Through its one-amplifier design, the regulator is also less complex and uses less die space.

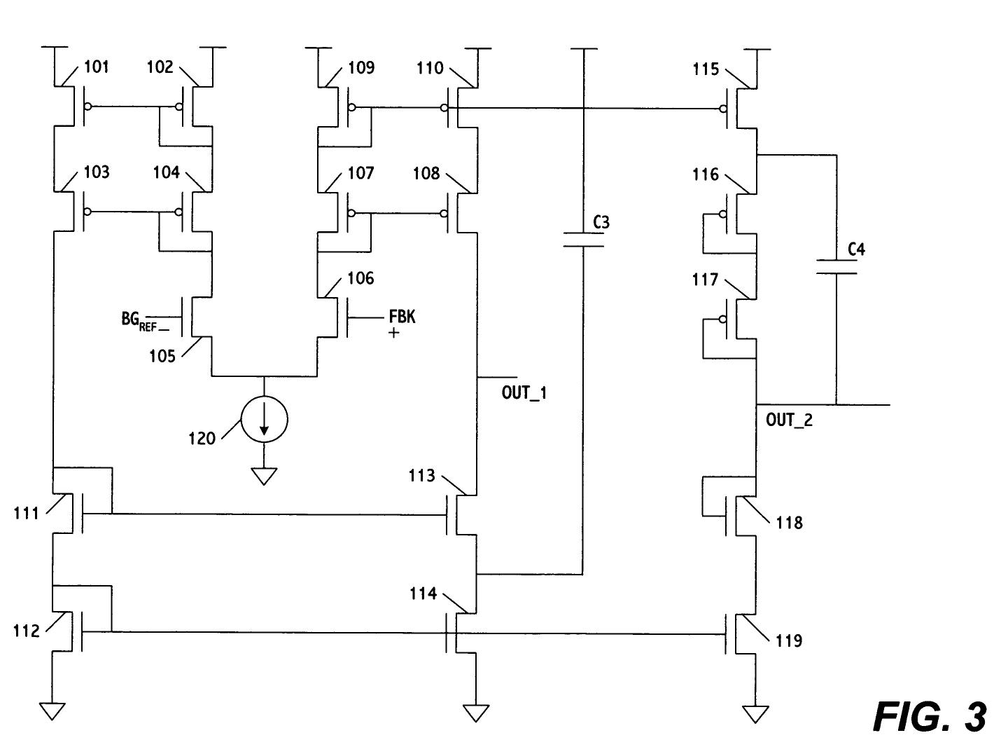

FIG. 3 shows a more detailed implementation of the amplifier included in the voltage regulator of FIG. 2. This amplifier includes differential transistor pair 105 and 106 which compare the reference (BGref) and feedback (FBK) voltages. The current generated in them is mirrored to the output nodes Out_{—}1 through current mirror pairs including transistor pair 101 and 102, transistor pair 103 and 104, transistor pair 111 and 113, transistor pair 112 and 114, transistor pair 109 and 110, and transistor pair 107 and 108. The current mirrors are cascoded to achieve high output impedance, and therefore to control the gain of the amplifier. Likewise, the current generated in transistors 105 and 106 is mirrored to output node Out_{—}2 through current mirror pairs, including transistor pair 101 and 102, transistor pair 103 and 104, transistor pair 111 and 118, transistor pair 112 and 119 and transistor pair 109 and 115. The Out_{—}2 node voltage is controlled through diode-connected transistors 116, 117, and 118.

In the FIG. 3 amplifier, the output (Out_{—}1) for the feed-back path has a slow response and provides the dominant pole in the loop. The output (Out_{—}2) for the feed-forward path is made up of series-connected current sources and diode-connected MOS transistors. The diode-connected MOS transistors ensure that the feed-forward path bias is clamped between (Vccsfr−2 Vtp) and Vtn. Here, Vccsfr is the supply voltage to the voltage regulator, Vtp is the p-type metal oxide semiconductor (PMOS) threshold voltage, and Vtn is the n-type metal oxide semiconductor (NMOS) threshold voltage.

In addition, supply-oriented feed-forward compensation capacitor C4 is used on the feed-forward path. This capacitor slows down the feed-forward path and therefore helps to reduce the transient voltage level in response to voltage disturbance within the loop. Moreover, rather than penalizing the supply rejection due to the slow down, the compensation capacitor actually improves the supply rejection because it provides a short cut for the supply disturbance to the feed-forward path.

A supply-oriented feed-forward compensation capacitor C3 is used on the feed-back path. The compensation provided by this capacitor allows optimization of the supply rejection for a given regulator efficiency target while maintaining positive the regulator resistance. The larger the C3 capacitance, the faster the feed-back path and therefore the better supply rejection. However, a faster feed-back path pushes the regulator resistance (or conductance) more towards the negative region. Using capacitor C3, a fine balance can be obtained by choosing how far away the regulator resistance stays from the negative region to accommodate PVT and random variation, as well as aging impact.

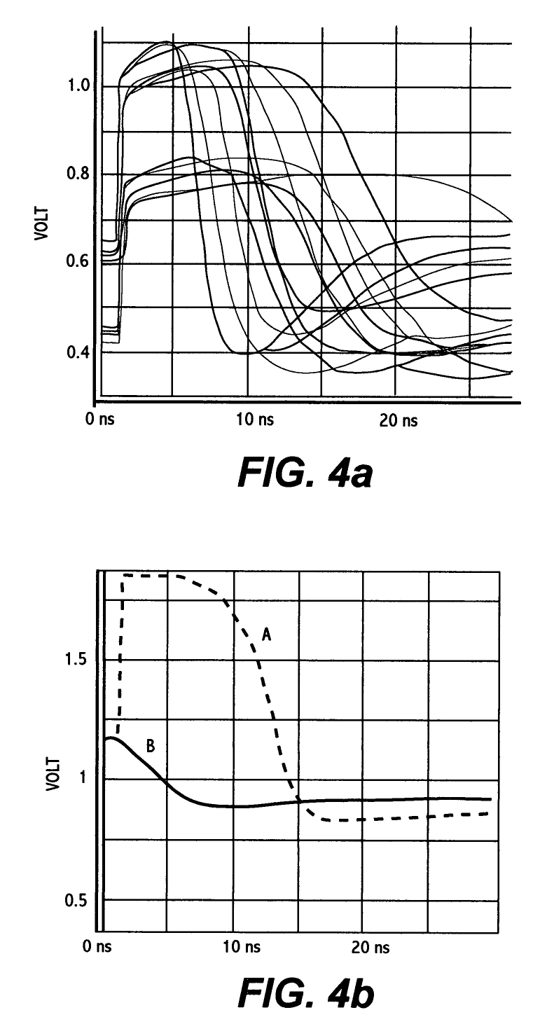

FIGS. 4a and 4b show an example of one level of performance that may be achieved using the voltage regulator of FIG. 2. In this example, the regulator output is forced to step from 1.15V to 0.9V switching into a typical power-saving mode. In FIG. 4a, the feed forward-path signal (ffctl) waveform is shown for process, voltage, and temperature variations. The ffctl signal voltage, and thus the gate voltage of transistor 60, is kept below 1.1V. In FIG. 4b, a worst case comparison is made between the voltage regulator of FIG. 2 and other types of voltage regulators. In these graphs, waveform B shows performance attainable by the FIG. 2 regulator and waveform A corresponds to the performance of other types of regulators. Also, the supply level powering the regulator varies from 1.52V to 1.85V in these graphs.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. A voltage regulator, comprising:
an amplifier having first and second outputs;
a feedback path coupled between a first input and the first output of the amplifier; and
a feed-forward path between the second output of the amplifier and a switch coupled to a reference potential, a first control signal from the second output of the amplifier to be generated based on a comparison of a reference signal and a feedback signal into the first input of the amplifier, the first control signal to control the switch to maintain a substantially constant supply voltage.

2. The voltage regulator of claim 1, wherein the feedback path and the feed-forward path are to intersect at an output node.

3. The voltage regulator of claim 2, further comprising:
a capacitor, coupled to the output node, to store a charge corresponding to the supply voltage.

4. The voltage regulator of claim 3, wherein the first control signal is to control the switch to couple the reference potential to the output node when the reference signal and the feedback signal are different, the reference potential to change the voltage stored in the capacitor to maintain the substantially constant supply voltage.

5. The voltage regulator of claim 4, wherein the first control signal is to control the switch to disconnect the reference potential from the output node when the reference signal at least substantially equals the feedback signal.

6. The voltage regulator of claim 1, wherein the feedback path includes:
a supply voltage source coupled to the switch,
wherein the feedback signal is to be generated from the supply voltage based on a second control voltage generated from the first output of the amplifier.

7. The voltage regulator of claim 6, wherein the second control voltage is to be generated based on a difference between the reference signal and the feedback signal.

8. The voltage regulator of claim 6, wherein the supply voltage source is coupled to a voltage divider through the switch.

9. A control circuit, comprising:
an amplifier having first and second outputs; and
a voltage adjuster coupled between a first input and the first output of the amplifier; and
a switch between the second output of the amplifier and a switch coupled to a reference potential, a first control signal from the second output of the amplifier to be generated based on a comparison of a reference signal and a feedback signal generated by the voltage adjuster, the first control signal to control the switch to maintain a substantially constant supply voltage.

10. The control circuit of claim 9, further comprising:
an output node coupled to the voltage adjuster and the switch; and
a capacitor, coupled to the output node, to store a charge corresponding to the supply voltage.

11. The control circuit of claim 10, wherein the first control signal is to control the switch to couple the reference potential to the output node when the reference signal and the feedback signal are different, the reference potential to change the voltage stored in the capacitor to maintain the substantially constant supply voltage.

12. The control circuit of claim 9, wherein the voltage adjuster is coupled between a voltage source and the second input of the amplifier, and wherein the feedback signal is to be generated from the voltage adjuster which adjusts a voltage supplied from the voltage source based on a second control voltage from the first output of the amplifier.
